(19) United States
(12) Patent Application Publication
(10) Pub. No.: US 2013/0138613 A1
(43) Pub. Date: May 30, 2013

(54) SYNTHETIC BACKUP DATA SET

(71) Applicants: Sudhakar PAULZAGADE, San Jose, CA (US); Ajay KUSHWAH, San Ramon, CA (US); CAO WU, Highgate (AU)

(72) Inventors: Sudhakar PAULZAGADE, San Jose, CA (US); Ajay KUSHWAH, San Ramon, CA (US); CAO WU, Highgate (AU)

(73) Assignee: QUANTUM CORPORATION, San Jose, CA (US)

(21) Appl. No.: 13/305,964

(22) Filed: Nov. 29, 2011

(51) Int. Cl. G06F 12/16; G06F 17/30

(52) U.S. Cl. 707/647; 707/E17.005

(57) ABSTRACT

Example apparatus and methods concern creating synthetic backups from existing backups. One example method includes accessing first information that is associated with an existing backup(s). The first information may be computer data that describes data stored on a backup media or appliance. The first information may be referred to as metadata. The existing backup may reside on a backup medium (e.g., tape), on a backup appliance (e.g., disk), or elsewhere. The example method includes instantiating second information (e.g., metadata) associated with a synthetic backup to be created. The second information may be stored on a non-transitory computer-readable medium. The example method also includes selectively manipulating the second information to create the synthetic backup. The manipulating may include copying portions of the first information into the second information. In one embodiment, the synthetic backup is only logically created and thus no data is copied from the existing backup.

### BACKGROUND

As the amount of data to be backed up continues to grow, more and more sophisticated approaches to backup are desired. These ever more sophisticated approaches seek to address the recovery time objective (RTO). One conventional backup application creates a new backup data set from fragments of previous backup data sets. The conventional backup application reads previously backed up data from a backup storage appliance onto a backup application media server. The previously backed up data may be read from different places including, for example, tapes, solid state devices, disks, or elsewhere. Conventionally, a synthetic backup data set is created from the previously backed up data that was read in and then the data associated with the synthetic backup data set is processed to create new image metadata and then written out to one or more backup storage appliances. This conventional approach is inefficient and resource intensive. Another conventional approach consolidated a set of incremental and/or differential backups to create a consolidated image that represented the entire source backup in a single image. Like other conventional approaches this may be inefficient due to reading and writing previously backed up data. Additional inefficiencies associated with conventional approaches include additional network overhead (e.g., when previously backed up data is read/written across a network), and extra workloads for both a backup application and a backup storage appliance.

A synthetic backup is a backup that is created by collecting data from a previous backup(s) rather than from an original source. The backup is referred to as a “synthetic” backup because it is not a backup created from original data. A synthetic full backup does not actually transfer data from an original non-backed up source (e.g., client computer) to backup media. Conventional synthetic backup methods are inefficient because they read and process previously backed up data from a backup storage appliance(s) and then write the previously backed up data to a backup storage appliance(s).

### BRIEF DESCRIPTION OF THE DRAWINGS

The accompanying drawings, which are incorporated in and constitute a part of the specification, illustrate various example apparatus, methods, and other example embodiments of various aspects of the invention. It will be appreciated that the illustrated element boundaries (e.g., boxes, groups of boxes, or other shapes) in the figures represent one example of the boundaries. One of ordinary skill in the art will appreciate that in some examples one element may be designed as multiple elements or that multiple elements may be designed as one element. In some examples, an element shown as an internal component of another element may be implemented as an external component and vice versa. Furthermore, elements may not be drawn to scale.

FIG. 1 illustrates a data stream.

FIG. 2 illustrates blocklets associated with a data stream.

FIG. 3 illustrates hashes associated with blocklets.

FIG. 4 illustrates binary large objects (BLOBs) constructed from blocklets and TAGs.

FIG. 5 illustrates actual backup data set(s).

FIG. 6 illustrates a synthetic backup data set created from an actual backup data set(s).

FIG. 7 illustrates a method associated with creating a synthetic backup data set.

FIG. 8 illustrates a method associated with creating a synthetic backup data set.

FIG. 9 illustrates a method associated with creating a synthetic backup data set.

FIG. 10 illustrates an apparatus associated with creating a synthetic backup data set.

FIG. 11 illustrates a backup method creating an actual backup data set.

FIG. 12 illustrates a backup method creating a synthetic backup data set.

### DETAILED DESCRIPTION

Example apparatus and methods concern synthetic backups. Example apparatus and methods construct a synthetic backup data set from information (e.g., metadata) associated with data (e.g., BLOB(s), portion(s) of BLOB(s), blocklet(s)) that have already been backed up. In one example, apparatus and methods use the information associated with a previous backup data set(s) already present on a backup storage appliance(s) to construct a synthetic backup data set “in place” without any movement (e.g., reading, writing) of previously backed up data. A backed up data set may be, for example, a copy of a live data set. The live data set may reside in a file system, on a server, or in association with some other entity. The backed up data may reside in a different location including, for example, on a backup medium or appliance (e.g., tape, disk).

Consider a trivial case where a new backup data set includes just a single member of a previously backed up data set. The previously backed up data set may include, for example, hundreds of BLOBs. Since the single member needed for the new backup is already present on a backup storage appliance, the new backup data set could just be described rather than reading in the single member and then writing the single member back out to a new, physical backup data set. The new backup data set could be synthesized from the existing backup data set by using just information for locating the previously stored data set. In this simple case, the synthetic backup could be stored as just location information for locating the single member from the previously stored data set. The information for locating the previously stored data set may be retrieved, for example, from metadata associated with the previously stored data.

Now consider a less trivial, but still straightforward case where a new backup data set is identical to a previously backed up data set. Conventional systems might read in the entire previously backed up data set and then write it back out and then create metadata for locating and using the new copy of the previously backed up data set. Example apparatus and methods would not be so inefficient. Instead, the new backup data set could be synthesized by creating metadata for the new backup data set. The metadata could include information for locating and using the previously backed up data set. The metadata could be retrieved, copied, or otherwise acquired from the metadata associated with the previously backed up data set. In this case, the synthetic backup could also be stored as just location information for locating the members in the previously stored data set. Other more complicated cases could be handled similarly.

Example apparatus and methods construct the synthetic backup data set based, at least in part, on information (e.g., metadata) associated with previously backed up data. The synthetic backup data set can be built “in place”, without reading all of the previously backed up data of which the backup image is composed. In one example, none of the previously backed up data will be read. In another example, at least one piece of the previously backed up data will be read. In one example, none of the previously backed up data will be written to a new location on a backup appliance. In another example, at least one piece of the previously backed up data will be written to a new location on a backup appliance.

Example apparatus and methods may be described using terminology familiar to one skilled in the art of data de-duplication. For example, figure one illustrates a “data stream.” A “data stream,” as used herein, refers to a contiguous sequence of bytes or characters or elements. A data stream may be of indeterminate but finite length. The first byte in a data stream is referred to as byte 0 (e.g., b₀). The illustrated data stream includes bytes b₀, b₁, b₂ . . . bₙ, where n is an integer and refers to the “n-th” byte.

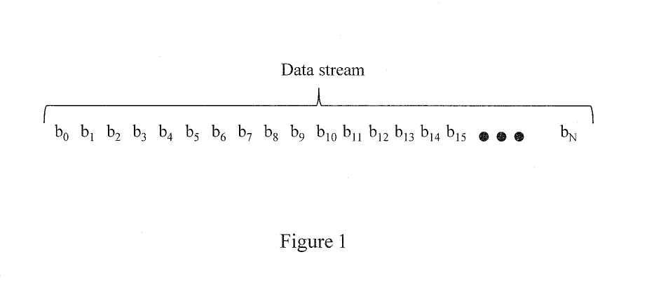

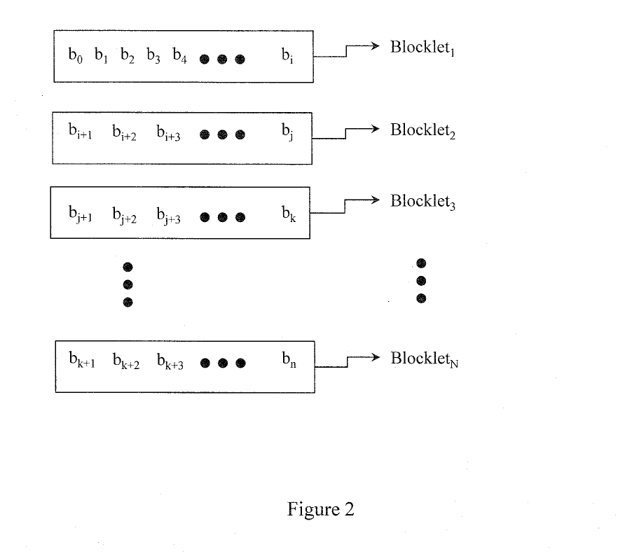

In one example, “blocklets” are atoms of unique data that may be stored by a data de-duplication system. FIG. 2 illustrates the data stream of FIG. 1 arranged as a collection of blocklets, blocklet₁, blocklet₂, blocklet_{N}. The blocklets may be created by the data de-duplication system using various approaches including, for example, fixed size partitioning, variable size partitioning, and others.

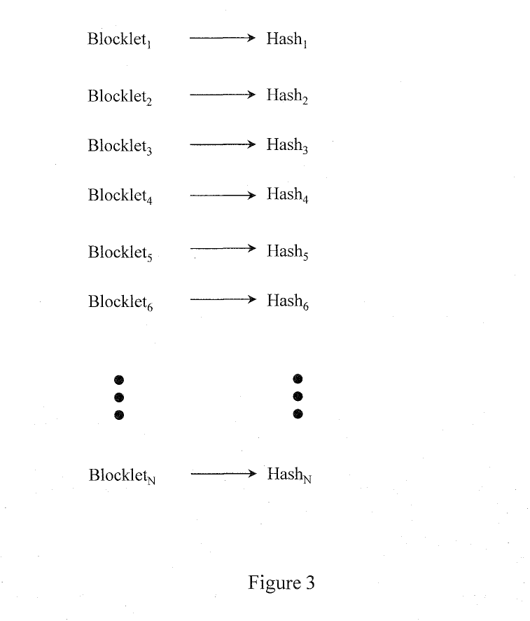

FIG. 3 illustrates hashes associated with blocklets. A hash can be used, for example, to uniquely identify a blocklet in a data de-duplication system. For example, hash₁ may identify blocklet₁, hash₂ may identify blocklet₂, and so on until hash_{N} identifies blocklet_{N}. A data de-duplication system may wish to keep track of blocklets and hashes. One way to keep track of blocklets and hashes is to index the blocklets using the hashes. However, it may be inefficient or simply undesirable to index each and every blocklet in a data de-duplication system. Therefore, some data de-duplication systems may store collections of blocklets in a larger container (e.g., a Binary Large Object (BLOB)) and then create an index to the BLOBs. A blocklet may be relatively small (e.g., 4 Kb, 16 Kb) as compared to a BLOB that is used to store a collection of blocklets. BLOBs may be, for example, on the order of 256 Mb. Increasing the container size facilitates reducing the index size.

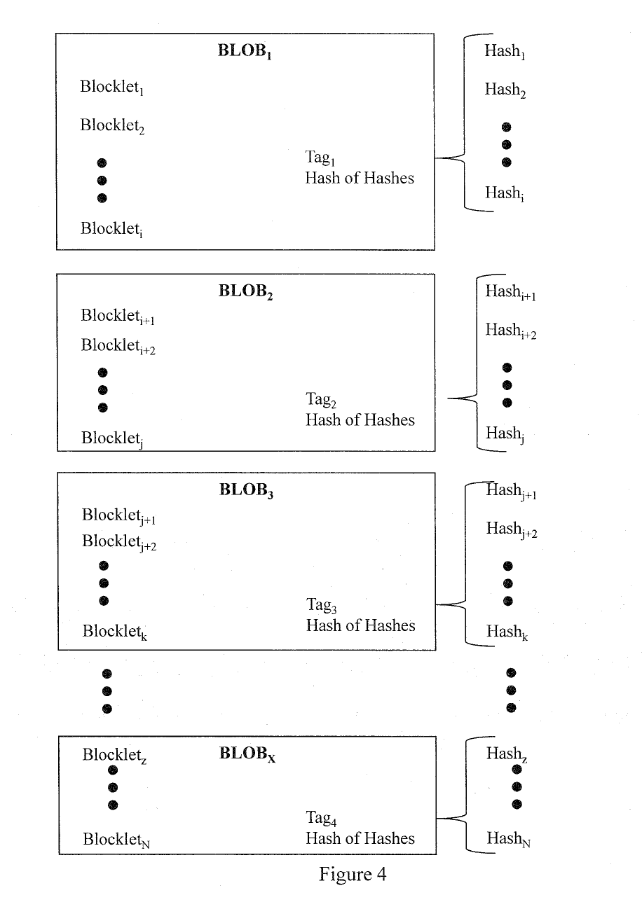

FIG. 4 illustrates BLOBs that store blocklets. For example, BLOB₁ stores blocklets 1 through i, BLOB₂ stores blocklets i+1 through j, BLOB₃ stores blocklets j+1 through k, and BLOB_{X} stores blocklets z through N. Some example data de-duplication systems may store individual hashes for blocklets stored in BLOBs. Other example data de-duplication systems may store a hash of the hashes of the blocklets stored in the BLOB. The hash of hashes may be referred to, for example, as a TAG. Additionally, metadata may be stored for a BLOB that stores a collection of blocklets. The metadata may include, for example, a list of blocklets stored in the BLOB, a corresponding list of hashes for the blocklets, a TAG associated with the BLOB, blocklet location information, BLOB location information, and other information. Backup applications may employ this metadata to create, manipulate, and/or access backup data sets. Backup applications may be tasked with making a backup copy of a file, of a file system, or of other collections of data that have been de-duplicated.

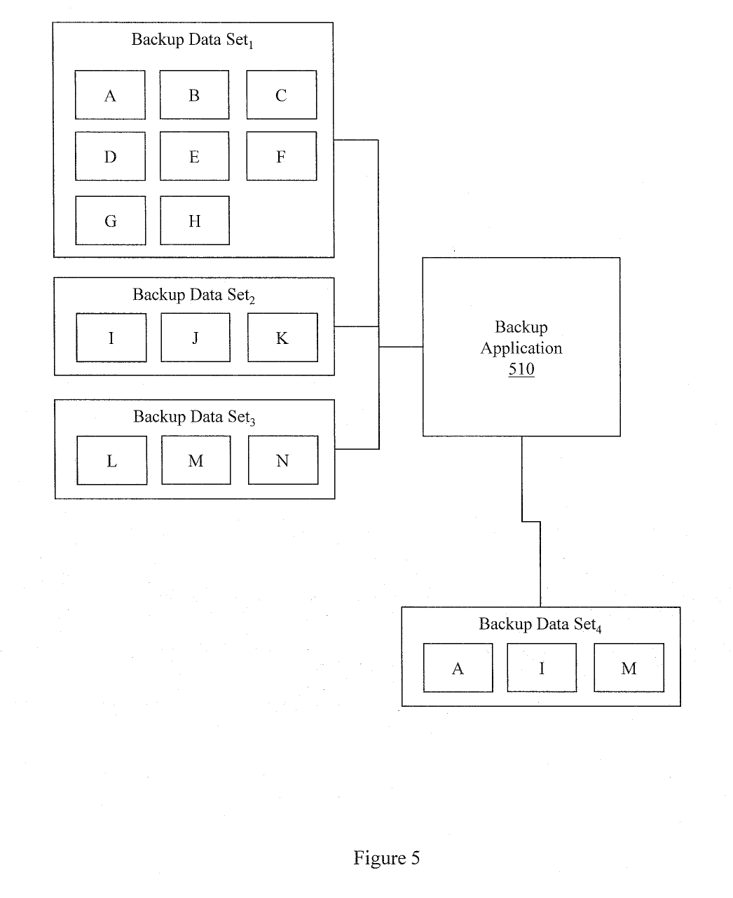

FIG. 5 illustrates three backup data sets. Backup data set₁ includes BLOBS A, B, C, D, E, F, G, and H. Backup data set₂ includes BLOBs I, J, and K. Backup data set₃ includes BLOBs L, M, and N. While the three backup data sets show mutually exclusive collections of BLOBs, it is possible that conventional backup data sets that store data that was not de-duplicated could include one or more duplicate BLOBs. Conventionally, if a new backup data set was to be created that included, for example, BLOBs A, I, and M, those three BLOBs would be read from their respective backup data sets into a backup application 510 from a backup storage appliance(s) on which the BLOB(s) were stored and then written out to the backup storage appliance(s) or a different backup storage appliance(s) as a new, physical backup data set (e.g., backup data set₄). Example apparatus and methods take a different approach to provide improved efficiencies in time and storage space.

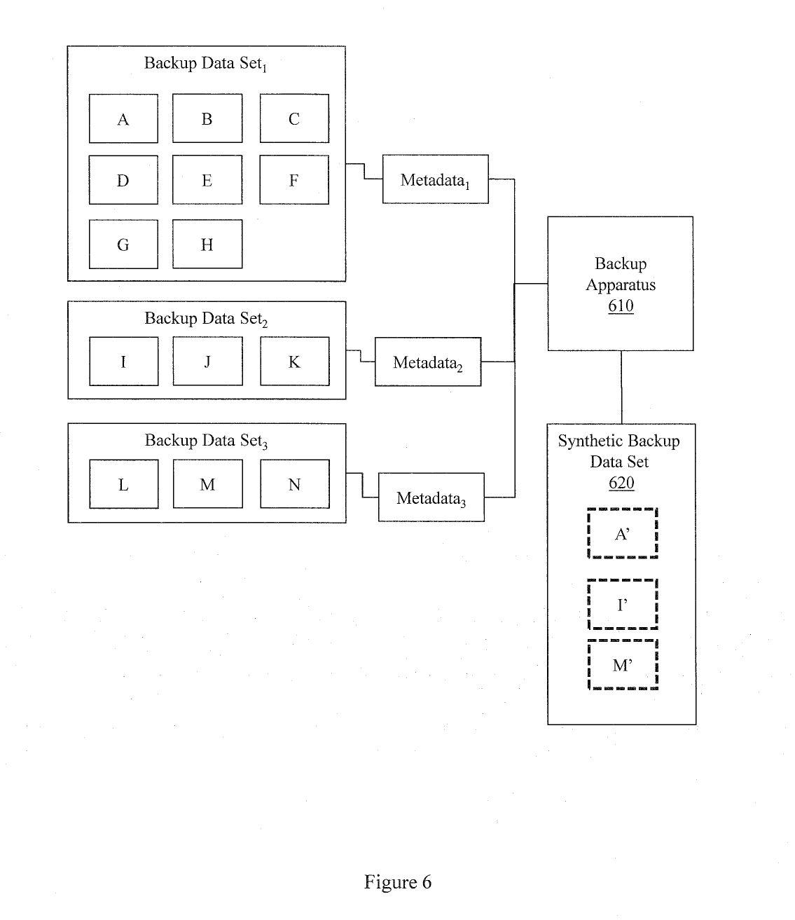

FIG. 6 illustrates the same three pre-existing backup data sets as FIG. 5. FIG. 6 also illustrates metadata associated with the backup data sets. For example, metadata₁ is associated with backup data set₁, metadata₂ is associated with backup data set₂, and metadata₃ is associated with backup data set₃. Example apparatus and methods create synthetic backup data set 620 based, at least in part, on the available metadata. Rather than read BLOBs from previous backup data sets, backup apparatus 610 may create synthetic backup data set 620 by storing metadata. For example, if the new backup is supposed to include BLOBs A, I, and M, then instead of reading BLOBs A, I, and M and then writing BLOBs A, I, and M to a backup appliance, backup apparatus 610 may instead write metadata associated with BLOBs A, I, and M to synthetic backup data set 620. The metadata associated with BLOB A is represented as box A′. Similarly, the metadata associated with BLOB I is represented as box I′ and the metadata associated with BLOB M is represented as box M′. In this simple example, the synthetic backup data set 620 was created using metadata associated with complete BLOBs from previously backed up data sets. However, more complicated cases may be handled. In this example, the BLOBs were not read then written in their new arrangement, only metadata was established and organized and then manipulated (e.g., populated) with metadata from existing metadata associated with the pre-existing backup data sets.

In FIG. 5, the backup data setₐ may consume, for example, three times 256 Mb of data for BLOBs A, I, and M and a few hundred bytes of metadata describing backup data setₐ. Creating backup data setₐ in FIG. 5 would include reading in the 768 Mb of data and then writing out the 768 Mb of data. Reading the 768 Mb of data could include, for example, mounting tapes in a tape library, positioning tapes, reading data, then un-mounting the tapes. This can take an undesirable amount of time. In FIG. 6, the synthetic backup data set 620 may only have consumed a few hundred bytes of metadata describing the locations of the BLOBs in other pre-existing backup data sets. Tapes would not have to be mounted, BLOBs would not have to be read, BLOBs would not have to be written, and tapes would not have to be un-mounted. Thus, the approach illustrated in FIG. 6 provides improvements over the approach illustrated in FIG. 5.

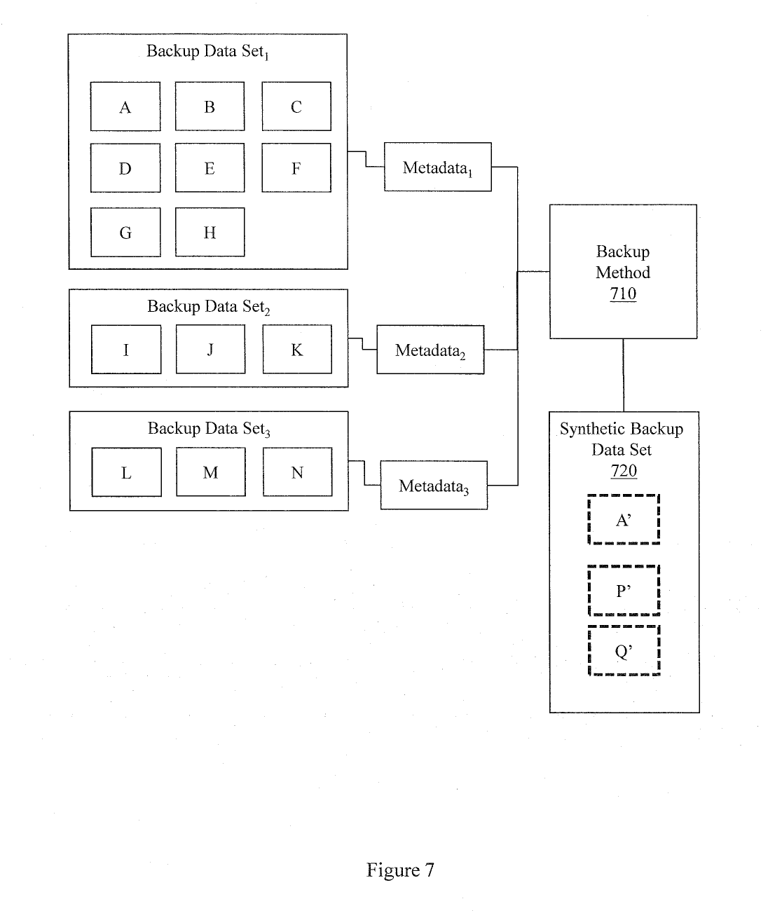

FIG. 7 illustrates a backup method 710 producing a synthetic backup data set 720 that includes BLOB A′, BLOB P′ and BLOB Q′. BLOB A′ corresponds to BLOB A in backup data set₁. BLOB P′ is made from parts of BLOBS I and J in backup data set₂. BLOB Q′ is made from parts of BLOBs B, K, and N from backup data set₁, backup data set₂, and backup data set₃ respectively. Since BLOB A′ corresponds to BLOB A, and since metadata about the location and accessing of BLOB A is available in metadata1, backup method 710 may not read BLOB A from backup data set₁ to create synthetic backup data set 720. Instead, backup method 710 may establish metadata for BLOB A′. Thus, instead of actually storing a copy of BLOB A as a BLOB A′, backup method 710 may just store metadata about BLOB A. This metadata is represented by BLOB A′.

Since BLOB P′ has portions of BLOBS I and J, in one example, portions of BLOBS I and J may be read by backup method 710 to facilitate creating metadata for BLOB P′. In one example, portions of BLOBS I and J may also be written to a backup appliance. In another example, it may not be necessary or desirable to read portions of the BLOBs I and J. Additionally, even if portions of BLOBS I and J may be read, it may not be necessary to write out portions of BLOBs I and J. Thus, instead of actually creating a new BLOB P′, backup method 710 may just store metadata about a portion of BLOB I and a portion of BLOB J. This metadata is represented by BLOB P′.

Since BLOB Q′ has portions of BLOBs A, K, and N, backup method 710 may read and/or write a portion(s) of one or more of the BLOBs A, K, and N to facilitate acquiring the metadata for BLOB Q′. However, as described above, it may not be necessary to read or write the portions of BLOBs A, K, or N. Thus, instead of actually creating a new BLOB Q′, backup method 710 may store metadata about a portion of BLOB A, a portion of BLOB K, and a portion of BLOB N. This metadata is represented by BLOB Q′.

Some portions of the detailed descriptions that follow are presented in terms of algorithms and symbolic representations of operations on data bits within a memory. These algorithmic descriptions and representations are used by those skilled in the art to convey the substance of their work to others. An algorithm, here and generally, is conceived to be a sequence of operations that produce a result. The operations may include physical manipulations of physical quantities. Usually, though not necessarily, the physical quantities take the form of electrical or magnetic signals capable of being stored, transferred, combined, compared, and otherwise manipulated in a logic, and so on. The physical manipulations create a concrete, tangible, useful, real-world result.

It has proven convenient at times, principally for reasons of common usage, to refer to these signals as bits, values, elements, symbols, characters, terms, numbers, and so on. It should be borne in mind, however, that these and similar terms are to be associated with the appropriate physical quantities and are merely convenient labels applied to these quantities. Unless specifically stated otherwise, it is appreciated that throughout the description, terms including processing, computing, determining, and so on, refer to actions and processes of a computer system, logic, processor, or similar electronic device that manipulates and transforms data represented as physical (electronic) quantities.

Example methods may be better appreciated with reference to flow diagrams. While for purposes of simplicity of explanation, the illustrated methodologies are shown and described as a series of blocks, it is to be appreciated that the methodologies are not limited by the order of the blocks, as some blocks can occur in different orders and/or concurrently with other blocks from that shown and described. Moreover, less than all the illustrated blocks may be required to implement an example methodology. Blocks may be combined or separated into multiple components. Furthermore, additional and/or alternative methodologies can employ additional, not illustrated blocks.

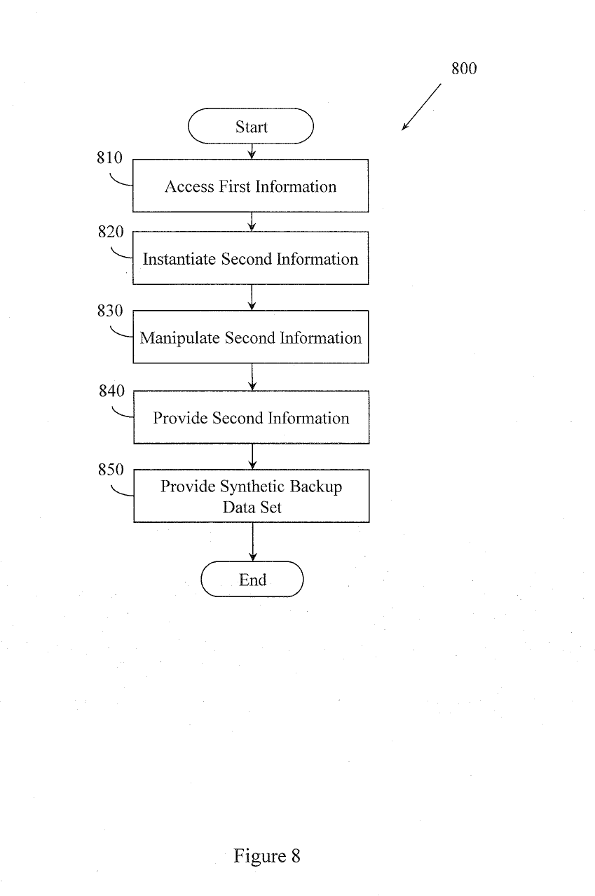

FIG. 8 illustrates a method 800 associated with creating a synthetic backup. Method 800 includes, at 810, accessing first information associated with an existing backup data set. In one example, the first information may be stored on a non-transitory computer-readable medium (e.g., memory, disk, tape). Accessing the first information may include, for example, opening a computer file in which the first information is stored, opening a database file in which the first information is stored, reading computer data from an object, reading computer data from a database record, establishing a link to a metadata server, and other actions. In one example, the existing backup data set may include one or more blocklets arranged in one or more BLOBs. In one example, the one or more blocklets and the one or more BLOBs may have been produced by a data de-duplication apparatus or method. In one embodiment, the existing backup data set may reside on a backup medium (e.g., tape), on a backup appliance (e.g., disk, solid state drive, tape library), or elsewhere.

Method 800 includes, at 820, instantiating second information associated with a synthetic backup data set to be created. In one example, the second information may be instantiated on a non-transitory computer-readable medium (e.g., memory, disk, solid state device). Instantiating the second information may include, for example, allocating memory to store computer data, initializing memory to store computer data, allocating a variable to store computer data, initializing a variable to store computer data, creating a database record to store computer data, initializing a database record, creating an object to store data, initializing an object, writing a record, writing to an object, and other actions.

Method 800 also includes, at 830, selectively manipulating the second information to create the synthetic backup data set. The manipulating is based, at least in part, on the first information. The manipulating may include, for example, copying values from the first information to the second information, deriving second information values from first information values, computing second information values from first information values, and other actions. In one example, a full backup data set may be created from previous full and incremental backup data sets.

In one example, the first information may be data about data, which may be referred to as metadata. Since the metadata is data about backed up data in a backup data set, in different examples the metadata may include a binary large object location, a binary large object size, a binary large object identifier (e.g., TAG), a binary large object order, a blocklet location, a blocklet size, a blocklet identifier, a blocklet order, or other information. A TAG for a BLOB may be, for example, a hash of the hashes of blocklets stored in the BLOB. Similarly, in one example, the second information may also be metadata about backed up data in a synthetic backup data set and may include a binary large object location, a binary large object size, a binary large object identifier (e.g., TAG), a binary large object order, a blocklet location, a blocklet size, a blocklet identifier, a blocklet order, or other information.

Instantiating the second information at 820 and manipulating the second information at 830 facilitate logically creating the synthetic backup from one or more elements of the existing backup data set without physically reading data from the existing backup data set from the backup appliance. One skilled in the art of computer science understands the difference between logically creating a data set and physically creating a data set. In one example, method 800 logically creates the members of the synthetic backup data set without physically writing a backup data set to the backup appliance. Even though the synthetic backup data set is only logically created, metadata about the synthetic backup data set may be physically created to store the references (e.g., pointers, addresses, location information) that will be used to access physical data associated with the logical synthetic backup data set. In one embodiment, method 800 may include reading some data from a previously backed up data set. For example, when an extent starts or ends somewhere other than at a blocklet boundary, then a portion of the extent may be read in and written out. An extent may start or end, for example, partway through a blocklet, partway through a shared memory page, or partway through some other storage location. In these examples, a small amount of data corresponding to the portion of the extent may be read and written.

In one embodiment, method 800 may also include, at 840, providing the synthetic backup data set to entities including, but not limited to, a backup apparatus, a backup server, a backup appliance, a backup stream, and a backup process. Providing the synthetic backup data set may include, for example, publishing the second information to entities including, but not limited to, a backup apparatus, a backup server, a backup appliance, a server, a process, a data stream, and an object. Providing the synthetic backup data set may also include, for example, storing the second information, storing the second information in a pre-determined location, writing a database record, writing data to an object, writing data to a server, and other actions.

In one embodiment, method 800 may also include, at 850, providing the second information to one or more of, the backup apparatus, the backup server, the backup appliance, the backup stream, and the backup process.

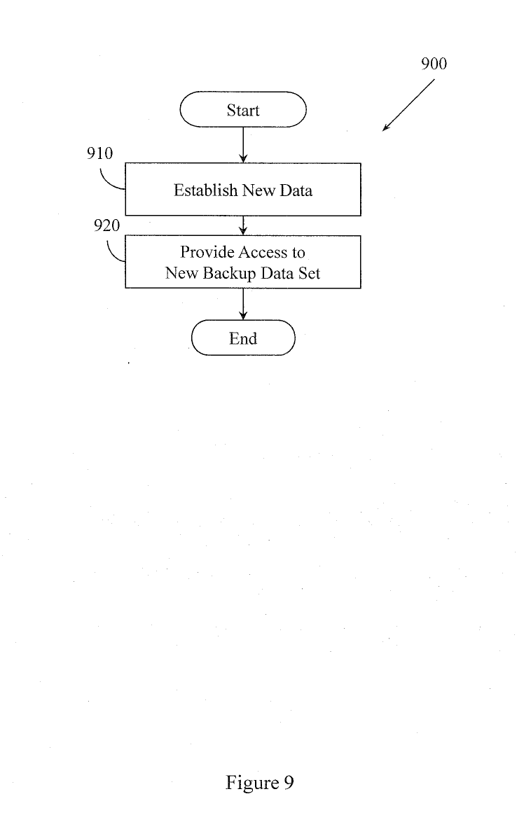

FIG. 9 illustrates a method 900 associated with creating a synthetic backup. Method 900 includes, at 910, establishing new data that describes a new backup data set. Instead of creating a new physical backup that includes backed up data and metadata, the new backup data set will be a synthetic backup data set that includes just metadata. The synthetic backup data set is created by reference to existing backed up data. In one example, the new data is created using existing data that describes one or more members of one or more existing backup data sets. In one example, establishing the new data that describes the new backup data set is done without accessing backed up data that is described by the existing data. In one embodiment, some data may be read from a previously backed up data set. For example, when an extent starts or ends somewhere other than at a blocklet boundary, then a portion of the extent may be read in and written out. In one example, a full backup data set may be created from previous full and incremental backup data sets.

The existing data may describe backed up data that is arranged in backed up data sets. In one example, the backed up data includes one or more BLOBs that store one or more blocklets. The BLOBs and the blocklets may have been produced, for example, by a data de-duplication apparatus or process. The existing data describes the backed up data and thus may include information about, for example, where the data is located, how big the data is, how the data is arranged, and other factors. In different examples, the existing data may include a binary large object location, a binary large object size, a binary large object identifier, a binary large object order, a blocklet location, a blocklet size, a blocklet identifier, and a blocklet order. The new data also describes backed up data and thus may include information including, but not limited to, the location of a binary large object, the size of a binary large object, an identifier (e.g., TAG) of a binary large object, an order in which binary large objects are arranged, the location of a blocklet, the size of a blocklet, an identifier (e.g., hash) of a blocklet identifier, and an order in which blocklets are arranged.

Method 900 also includes, at 920, providing access to the new backup data set through the new data. In one example, providing access to the new backup data set through the new data is done without writing backed up data that is described by the new data. Providing access to the new backup data set may include, for example, storing the new data in a location accessible to a backup application, storing the new data in a location accessible to a backup appliance, writing the new data to a pre-determined location, writing a set of database records, writing data to an object, writing data to a server, and other actions.

While the figures illustrate various actions occurring in serial, it is to be appreciated that various actions illustrated in the figures could occur substantially in parallel. By way of illustration, a first process could process existing metadata, and a second process could process the new metadata created for a synthetic backup. While two processes are described, it is to be appreciated that a greater and/or lesser number of processes could be employed and that lightweight processes, regular processes, threads, and other approaches could be employed.

In one example, a method may be implemented as computer executable instructions. Thus, in one example, a computer-readable medium may store computer executable instructions that if executed by a machine (e.g., processor) cause the machine to perform methods described herein. While executable instructions associated with the described methods are described as being stored on a computer-readable medium, it is to be appreciated that executable instructions associated with other example methods described herein may also be stored on a computer-readable medium.

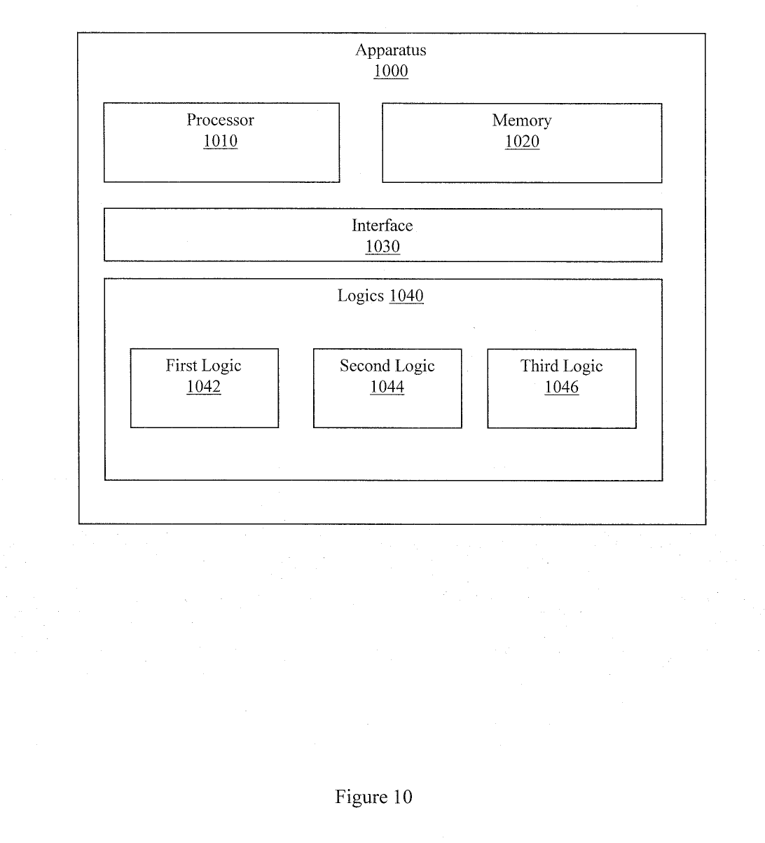

FIG. 10 illustrates an apparatus 1000 for creating a synthetic backup data set from a previously backed up data set(s). In one example, the synthetic backup data set is created without moving previously backed up data. Instead of reading previously backed up data, creating metadata about a new backup data set, and then writing the new backup data set, apparatus 1000 may create the synthetic backup by establishing metadata that refers to existing backed up data.

Apparatus 1000 includes a processor 1010, a memory 1020, a set 1040 of logics, and an interface 1030 to connect the processor 1010, the memory 1020, and the set 1040 of logics. In one embodiment, apparatus 1000 may be a special purpose computer that is created as a result of programming a general purpose computer. In another embodiment, apparatus 1000 may include special purpose circuits that are added to a general purpose computer to produce a special purpose computer.

In one embodiment, the set 1040 of logics includes a first logic 1042, a second logic 1044, and a third logic 1046. In one embodiment, the first logic 1042 is configured to process first metadata associated with an existing backup. In one example, the first logic 1042 may be configured to process the first metadata without reading the data in the existing backup to which the first metadata refers. Instead of reading the data in the existing backup to which the first metadata refers, just the first metadata may be accessed. In one embodiment, the second logic 1044 is configured to process second metadata associated with a synthetic backup. In one example, the second logic 1044 is configured to process the second metadata without writing the data to which the second metadata refers.

In different examples the first metadata may include a binary large object location, a binary large object size, a binary large object identifier, a binary large object order, a blocklet location, a blocklet size, a blocklet identifier, and a blocklet order. Similarly, in different examples, the second metadata may include a binary large object location, a binary large object size, a binary large object identifier, a binary large object order, a blocklet location, a blocklet size, a blocklet identifier, and a blocklet order.

In one embodiment, the third logic 1046 is configured to produce the synthetic backup by controlling the first logic 1042 to provide members of the first metadata sufficient to describe the synthetic backup. The third logic 1046 may also be configured to produce the synthetic backup by controlling the second logic 1044 to store in the second metadata information sufficient to describe the synthetic backup. In one example, the third logic 1046 is configured to receive a description of the contents of the synthetic backup. Once the third logic 1046 has the description of the contents of the synthetic backup, the third logic 1046 may control the first logic 1042 to locate members of the first metadata sufficient to provide information for describing members of the synthetic backup as controlled by the description of the contents of the synthetic backup. Similarly, once the third logic 1046 has the description of the contents of the synthetic backup, the third logic 1046 may then control the second logic 1044 to write sufficient data as controlled by the description of the contents of the synthetic backup.

In one example, the synthetic backup data set refers to one or more blocklets stored in one or more BLOBs. The one or more blocklets and the one or more BLOBs may have been stored in one or more previously created physical backup data sets. In one example, the data to which the first metadata refers may have been produced by a data de-duplication apparatus or process.

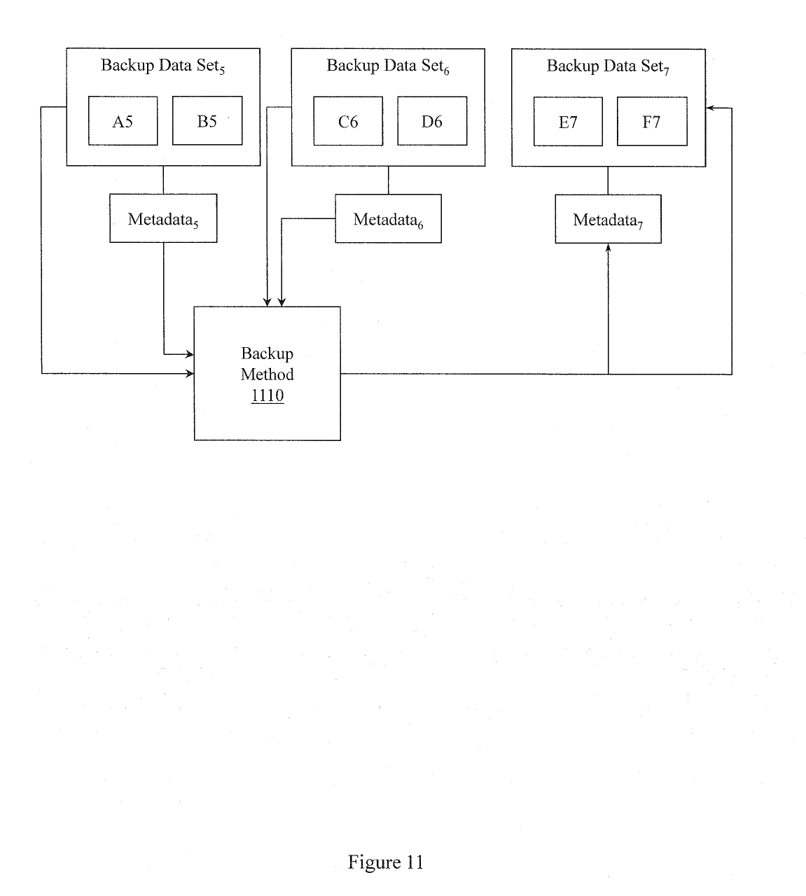

FIG. 11 illustrates a backup method 1110 producing both a backup data set₇ and metadata, from pre-existing backup data set₅, metadata₅, pre-existing backup data set₆, and metadata₆. To create backup data set₇, data is actually read from the pre-existing data sets and data is actually written to the new physical backup data set.

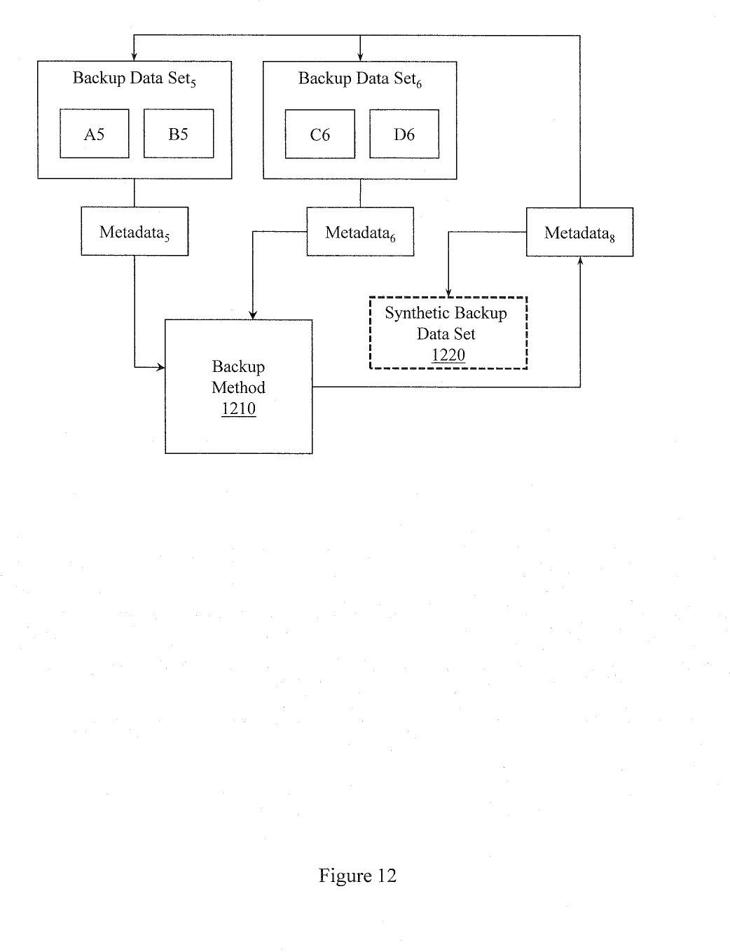

FIG. 12 illustrates a backup method 1210 logically producing a synthetic backup data set 1220 by creating metadata₈ without creating additional backed up data. In one example, to create synthetic backup data set 1220, backed up data does not have to be read from the pre-existing backup data sets and backed up data does not have to be written to a new backup data set, only metadata₈ has to be processed.

The following includes definitions of selected terms employed herein. The definitions include various examples and/or forms of components that fall within the scope of a term and that may be used for implementation. The examples are not intended to be limiting. Both singular and plural forms of terms may be within the definitions.

References to “one embodiment”, “an embodiment”, “one example”, “an example”, and so on, indicate that the embodiment(s) or example(s) so described may include a particular feature, structure, characteristic, property, element, or limitation, but that not every embodiment or example necessarily includes that particular feature, structure, characteristic, property, element or limitation. Furthermore, repeated use of the phrase “in one embodiment” does not necessarily refer to the same embodiment, though it may.

“Computer-readable medium”, as used herein, refers to a medium that stores instructions and/or data. A computer-readable medium may take forms, including, but not limited to, non-volatile media, and volatile media. Non-volatile media may include, for example, optical disks, magnetic disks, and so on. Volatile media may include, for example, semiconductor memories, dynamic memory, and so on. Common forms of a computer-readable medium may include, but are not limited to, a floppy disk, a flexible disk, a hard disk, a magnetic tape, other magnetic medium, an ASIC, a CD, other optical medium, a RAM, a ROM, a memory chip or card, a memory stick, and other media from which a computer, a processor or other electronic device can read.

“Data store”, as used herein, refers to a physical and/or logical entity that can store data. A data store may be, for example, a database, a table, a file, a list, a queue, a heap, a memory, a register, and so on. In different examples, a data store may reside in one logical and/or physical entity and/or may be distributed between two or more logical and/or physical entities.

“Logic”, as used herein, includes but is not limited to hardware, firmware, software in execution on a machine, and/or combinations of each to perform a function(s) or an action(s), and/or to cause a function or action from another logic, method, and/or system. Logic may include a software controlled microprocessor, a discrete logic (e.g., ASIC), an analog circuit, a digital circuit, a programmed logic device, a memory device containing instructions, and so on. Logic may include one or more gates, combinations of gates, or other circuit components. Where multiple logical logics are described, it may be possible to incorporate the multiple logical logics into one physical logic. Similarly, where a single logical logic is described, it may be possible to distribute that single logical logic between multiple physical logics.

While example apparatus, methods, and computer-readable media have been illustrated by describing examples, and while the examples have been described in considerable detail, it is not the intention of the applicants to restrict or in any way limit the scope of the appended claims to such detail. It is, of course, not possible to describe every conceivable combination of components or methodologies for purposes of describing the systems, methods, and so on described herein. Therefore, the invention is not limited to the specific details, the representative apparatus, and illustrative examples shown and described. Thus, this application is intended to embrace alterations, modifications, and variations that fall within the scope of the appended claims.

To the extent that the term “includes” or “including” is employed in the detailed description or the claims, it is intended to be inclusive in a manner similar to the term “comprising” as that term is interpreted when employed as a transitional word in a claim.

To the extent that the term “or” is employed in the detailed description or claims (e.g., A or B) it is intended to mean “A or B or both”. When the applicants intend to indicate “only A or B but not both” then the term “only A or B but not both” will be employed. Thus, use of the term “or” herein is the inclusive, and not the exclusive use. See, Bryan A. Garner, A Dictionary of Modern Legal Usage 624 (2d. Ed. 1995).

To the extent that the phrase “one or more of, A, B, and C” is employed herein, (e.g., a data store configured to store one or more of, A, B, and C) it is intended to convey the set of possibilities A, B, C, AB, AC, BC, and/or ABC (e.g., the data store may store only A, only B, only C, A&B, A&C, B&C, and/or A&B&C). It is not intended to require one of A, one of B, and one of C. When the applicants intend to indicate “at least one of A, at least one of B, and at least one of C”, then the phrasing “at least one of A, at least one of B, and at least one of C” will be employed.

1. A method, comprising:
accessing first information associated with an existing backup data set, the first information being stored on a non-transitory computer-readable medium, the existing backup data set residing on a backup appliance;
instantiating, on a non-transitory computer-readable medium, second information associated with a synthetic backup data set to be created; and
selectively manipulating the second information to create the synthetic backup data set, where the manipulating is based, at least in part, on the first information.

2. The method of claim 1, where the existing backup data set comprises one or more blocklets arranged in one or more binary large objects.

3. The method of claim 2, where the one or more blocklets and the one or more binary large objects are a data de-duplication work product.

4. The method of claim 2, the first information being metadata concerning one or more of, a binary large object location, a binary large object size, a binary large object identifier, a binary large object order, a blocklet location, a blocklet size, a blocklet identifier, and a blocklet order.

5. The method of claim 4, a blocklet identifier being a hash, and a binary large object identifier being a hash of hashes of blocklets stored in the binary large object.

6. The method of claim 4, where the second information is metadata concerning one or more of, a binary large object location, a binary large object size, a binary large object identifier, a binary large object order, a blocklet location, a blocklet size, a blocklet identifier, and a blocklet order.

7. The method of claim 6, where selectively manipulating the second information comprises copying one or more pieces of information from the first information to the second information.

8. The method of claim 7, where the synthetic backup data set is logically created from one or more elements of the existing backup data set without physically reading data from the existing backup data set from the backup appliance.

9. The method of claim 8, where the synthetic backup data set is logically created without physically writing a backup data set to the backup appliance.

10. The method of claim 1, comprising:
providing the synthetic backup data set to one or more of, a backup apparatus, and a backup process; and
providing the second information to one or more of, the backup apparatus, and the backup process.

11.-20. (canceled)

21. The method of claim 1, where the existing backup data set is not an incremental backup data set.

22. The method of claim 4, where the synthetic backup data set includes no data from the existing backup data set.
